(19) United States
(12) Patent Application Publication
(10) Pub. No.: US 2026/0064234 A1
(43) Pub. Date: Mar. 5, 2026

(54) GRAPHICAL USER INTERFACE WITH SYNCHRONIZED PANES FOR LINKED DOCUMENT NAVIGATION

(71) Applicant: R-Space Technologies, Inc., New York, NY (US)

(72) Inventors: Rachel Juliette Mannina, New York, NY (US); Kristy Ann Caster, Des Moines, WA (US); Mackenzie Taylor Tjogas, Santa Monica, CA (US)

(21) Appl. No.: 19/311,239

(22) Filed: Aug. 27, 2025

Related U.S. Application Data
(60) Provisional application No. 63/688,090, filed on Aug. 28, 2024.

(51) Int. Cl. G06F 3/0481; G06F 3/04842; G06F 40/205; G06Q 50/08

(52) U.S. Cl. CPC G06F 3/0481; G06F 3/04842; G06F 40/205; G06Q 50/08

(57) ABSTRACT

A platform that generates submittal reviews electronically for various construction projects. Embodiments include receiving project submittals by the reviewer, inputting the submittal in a web application interface, receiving the output in a specific format, reviewing the submittal review generated then downloading the reviewed submittal and handing it to a subsequent party for review. In some embodiments, during project initialization, project specifications and drawings are ingested. The project specifications and drawings are processed to extract relevant content, which is used to perform each submittal review. Artificial intelligence (AI) models are prompted through a series of dependent prompt engineered queries. The queries to the AI are broken into preconfigured pieces which improves the accuracy of the AI model. In order to break down the AI queries, the platform builds a program structure around making required calls to an AI API that are tuned for a particular program goal.

### CROSS-REFERENCE TO RELATED APPLICATION(S)

This application claims priority to U.S. Provisional Application No. 63/688,090, filed Aug. 28, 2024, entitled “SYSTEMS AND METHODS FOR ELECTRONICALLY GENERATING SUBMITTAL REVIEWS,” which is hereby incorporated in its entirety.

### BACKGROUND

On construction projects, the act of reviewing and processing submittals is a long and tedious process. Team members spend a significant amount of time on submittal review, up to hours per day. For the general contracting team, submittal review involves ensuring the submittal meets project requirements, logging the submittal, then managing the submittal review cycles until final approval is confirmed. Most of the time spent on submittal review is searching for and understanding the relevant project requirements to perform the submittal review against, which is a process that takes time and expertise. Project documents involved in these reviews are typically project drawings and specifications, which are voluminous and include a large amount of data. Further, reading and comprehending hundreds of pages of details from these documents of a project to perform submittal reviews within the allotted amount of time is nearly impossible.

In such scenarios, most often the submittal reviews are incomplete or inaccurate, creating loopholes which can affect the project quality, project schedules, and project budgets. Hence there remains an unmet need for systems and methods that generate submittal reviews electronically, with a higher level of accuracy and efficiency and in a fraction of the time compared to traditional ways, along with less human effort. Artificial intelligence (“AI”) models often operate based on extensive and enormous training models. The models include a multiplicity of inputs and how each should be handled. Then, when the model receives a new input, the model produces an output based on patterns determined from the data the model was trained on.

Large language models (“LLMs”) are trained using large datasets to enable them to perform natural language processing (“NLP”) tasks such as recognizing, translating, predicting, or generating text or other content. One example of an existing LLM is GPT-4 (Generative Pre-trained Transformer 4) developed by OpenAI. A recent trend in AI is to make use of general-purpose generative AI applications built on LLMs. An example of such an application is ChatGPT, which is based on the GPT family of OpenAI models. ChatGPT and similar applications make use of a natural language chat interface for humans to interact with the underlying AI. These applications typically include additional processing layers and fine-tuning on top of the base LLM to make them more suitable for conversational interactions. At the time of filing, general-purpose generative AI's first attempt at responding to a user's queries is middling and requires query refinement from the user. Over the course of a given chat session, the user refines their queries, and the general-purpose model provides a better response.

Plug-ins, short for “plug-in software” or “add-ons,” are modular components that extend the functionality of a software application by providing additional features or capabilities. Plug-ins follow a modular design, allowing developers to create and distribute them separately from the core application. Plug-ins interface with the client application through predefined Application Programming Interfaces (APIs) or hooks in the software's architecture, allowing the plug-in to access and augment the functionalities of the client application.

### BRIEF DESCRIPTION OF THE DRAWINGS

FIG. 1 is a diagram illustrating an AI submittal platform, according to an embodiment of the disclosed technology.

FIG. 2 is a flowchart illustrating a method of comparing submittal specs with project requirements.

FIG. 3 is a screenshot of a first embodiment of an upload interface of a submittal platform.

FIG. 4 is a screenshot of a first embodiment of a tripartite interface of a submittal platform with collapsed details.

FIG. 5 is a screenshot of a first embodiment of a tripartite interface of a submittal platform with expanded details.

FIG. 6 is a screenshot of a first embodiment of a tripartite interface of a submittal platform with a requirements evaluation pane.

FIG. 7A is a screenshot of a second embodiment of a tripartite interface of a submittal platform with a requirements evaluation pane.

FIG. 7B is a screenshot of a third embodiment of a tripartite interface of a submittal platform with a requirements evaluation pane.

FIG. 8 is a screenshot of a fourth embodiment of a tripartite interface of a submittal platform with a requirements evaluation pane.

FIG. 9A is a screenshot of a first embodiment of a tripartite interface of a submittal platform with a detail window on the requirements evaluation pane.

FIG. 9B is a screenshot of a first embodiment of a tripartite interface of a submittal platform with a “non-applicable” indicator.

FIG. 9C is a screenshot of a first embodiment of a tripartite interface of a submittal platform with a window for changing a requirement status.

FIG. 10 is a screenshot of a first embodiment of a tripartite interface of a submittal platform with a quick contact link on the requirements evaluation pane.

FIG. 11 is a screenshot of a first embodiment of a tripartite interface of a submittal platform with a project notes pane.

FIG. 12 is a screenshot of a first embodiment of a tripartite interface of a submittal platform with a submittal actions pane.

FIG. 13 is a screenshot of a first embodiment of a tripartite interface of a submittal platform with a record output control.

FIG. 14 is a screenshot of an embodiment of an output of a submittal platform.

FIG. 15 is a screenshot of a first alternate embodiment of a tripartite interface of a submittal platform.

FIG. 16 is a screenshot of a first embodiment of a tripartite interface of a submittal platform with a detail view.

FIG. 17 Is a flow chart illustrating a method of clearing a submittal process via AI examination of documents.

FIG. 18 is a block diagram illustrating an example computer system, in accordance with one or more embodiments.

FIG. 19 is a high-level block diagram illustrating an example AI system, in accordance with one or more embodiments.

### DETAILED DESCRIPTION

It is to be understood that this application is not limited to the particular systems and methods described, as there may be multiple possible embodiments that are not expressly illustrated in the present disclosure. It is also to be understood that the terminology used in the description is for the purpose of describing the particular versions of embodiments only and is not intended to limit the scope of the present application.

In accordance with the present disclosure, aspects include providing a method and system for generating an electronic submittal review from given project documents and submittals for various construction projects.

In one example of embodiment, aspects provide a method and system for generating submittal reviews electronically for various construction projects. Embodiments of the method and system include receiving project submittals by the reviewer, inputting the submittal in a web application interface, receiving the output in a specific format (e.g., tripartite), reviewing the submittal review generated and then downloading the reviewed submittal (PDF), and handing it to a subsequent next party for review. In some embodiments, during project initialization, project specifications and drawings are ingested either manually or via API to hosting system. The project specifications and drawings are then stored to perform each submittal review against them.

Methods and systems disclosed herein can be performed with respect to any type of artifact. Artifacts can include construction submittals, specifications, drawings, and any other relevant documentation, media, or materials. Examples of construction submittals include shop drawings, product data, mockups, samples, or other submittal types known in the art created by the contractor in charge of the work and presented to the project owner through the delegated design team (architect, engineers, authority having jurisdiction) for review and approval. The project documents are updated frequently via the API when a change to the documents triggers the system. The submittals help demonstrate that proposed plans and materials match the details in the construction contract (i.e., project drawings and specifications).

The present disclosure outlines a version of the system that is commonly used by the general contractor project management team; though, the submittal process extends outside of the general contractor. Submittal documents originate at the manufacturer/subcontractor level and are typically prepared and submitted by the subcontractor that is providing the materials for the project. Subcontractors send the submittal to the general contracting team. The general contracting team reviews the submittal against the project documents to ensure it meets project requirements as shown on documents such as specifications and drawings. Once their review is complete, they perform administrative actions such as submittal naming, creating a submittal coversheet, and logging the submittal in the relevant project management system (Autodesk/Procore/CMIC, etc.) before sending it to the design team for final review. The design team (architect/engineers) then review the submittal and provide their formal response: if it is approved for use or if it is rejected and revisions are requested. The general contractor receives the submittal back from the design team and reviews their judgement, notes any action items, then closes the submittal and distributes it back to the subcontracting team and any other trades involved. For a submittal that is rejected, this process is repeated until the submittal is approved by the design team.

Submittals have a great deal of intelligence and information within them. For this reason, the submittal review process can evoke new questions, clarifications, follow-up items, and even additional scope identification. In some embodiments, the system can include features for analyzing submittals. This feature can be designed to identify and extract any scope changes indicated. The system can utilize optical character recognition (OCR) technology or other document analysis techniques to scan the returned submittal for specific annotations or comments indicating scope changes. Once identified, these scope changes can be presented to the user as action items for tracking purposes. The system can offer multiple options for addressing these scope changes, which can include generating a Request for Information (RFI), drafting an email to relevant parties, or initiating the process of creating a change order. Users can have the flexibility to select one or more of these actions based on the nature and significance of the scope change. This automated identification and tracking of scope changes can help streamline the submittal review process, ensure that important modifications are not overlooked, and can facilitate prompt and appropriate responses to feedback (e.g., any comments or changes that are shown in a submittal response). The disclosed methods and systems aim to cover disclosures also related to the ingestion of this type of content, to be used in various ways for client and project benefit.

AI applications (generative and otherwise) have emerged as powerful tools across various domains, from natural language processing to content creation, providing capabilities to generate human-like responses and creative outputs. Users interact with these applications, often powered by Large Language Models (LLMs), through client interfaces, seeking responses, recommendations, or creative outputs tailored to their inputs. While LLMs or generative AIs are capable of outputting impressive content, they can frequently become baffled with large queries or multi-step queries. Allowing the AI to organize its responses leaves room for a lot of error and the possibility of unusable output.

An improvement to the AI is a guidance system that focuses an AI on small pieces of a greater query. If asked to do the whole job at once, the AI will struggle. However, if the queries to the AI are broken into preconfigured pieces, the results from the AI and the corresponding prompt engineering efforts are more effective at getting good output from the AI. One way to break down the AI queries is to build a program structure around making required calls to an AI API that are tuned for a particular program goal. For example, a first query is to chunk a document into smaller bits of text that are identified by document formatting or context. A program then fills object values with the chunks and is enabled to ask an additional query pertaining to the chunks (e.g., match one set of chunks to another set of chunks and provide a match confidence) and have the API communicate by inserting the object values (e.g., the chunked text) as query elements.

In some embodiments, breaking down the AI queries even further improves accuracy. For example, a program structure initiates separate queries for each chunk (individually) from one document as compared against each chunk from another and seeks to find the most relevant text. If more than one set of “relevant text” is identified, a follow-up query requests the AI choose a single set of text. Then a follow-up query seeks whether the identified relevant text satisfies a requirement of the queried chunk. In this manner, the AI query structure is embodied with a tree structure where each subsequent query is dependent on the previous query, and the queries branch for each relevant object.

A given user or organization level user is further enabled to further train of the platform suggestions. When a requirement is unmet/unsure, there is a prompt that recommends the best next steps to assist the user in confirming the requirement is addressed, which also helps instruct new users on how best to navigate through a successful submittal review. However, similar issues are typically experienced within specific to each submittal product, submittal type or submittals related to a specification sections. Thus, over time, those similar issues and how they were resolved are collected as training data that is used to train a user specific model tied to those submittal issue categories. This data can also be collected upon ingestion of the firm's historical submittal data, with the appropriate consents from the firm to use said data for such purposes.

The user specific model tunes the user interface and the explanation for unmet/unsure requirements to empower users to best understand the things that are important to look out for in submittal reviews and could include client specific insights (pending client consent) that note past successes or errors around certain submittal products or submittals related to a certain specification section. For example, using the submittal platform a first time enables the platform to record the number of clicks, interactions, messages sent, screen time, mouse cursor lingering time, and other known engagement metrics to identify pain points or difficult elements of the submittal process. Presuming there was a solution to a corresponding issue from the first usage of the platform, the platform may offer up that solution early on to shortcut the previously experienced process.

In some embodiments, when a given requirement is met with/by a given product, subcontractor, material, or other project element, both the requirement and the submittal used to satisfy that requirement are cached/stored by the platform (e.g., in vectorized or tokenized format). Upon receipt of a new project document, the new requirements are compared against the previously stored requirements (e.g., again such as in vectorized or tokenized formats). For matching requirements, the prior submittal solution to those requirements is offered to the user.

The user-specific insights empower users to learn from the platform and not make the same mistakes. The insights relate to similar products, subcontractor submittal performance, materials that were used in the past that relate to each submittal review that comes up, or historical project performance. These insights can be used in a multitude of ways. By extracting data through the submittal process, at times coupled with data received from connected project systems (such as a Project Management Software), the platform can identify unique trends. Users and clients can use these trends to perform predictive analysis, which can prompt project specific actions.

The invention is implemented in numerous ways, including as a process; an apparatus; a system; a composition of matter; a computer program product embodied on a computer-readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description that references the accompanying figures follows. The scope of the invention is limited only by the claims and the invention encompasses numerous alternatives, modifications, and equivalents. Numerous specific details are set forth in the following description in order to provide a thorough understanding of the disclosure. These details are provided for the purpose of example and the invention may be practiced according to the claims without some or all of these specific details. For the purpose of clarity, technical material that is known in the technical fields related to the invention has not been described in detail so that the invention is not unnecessarily obscured.

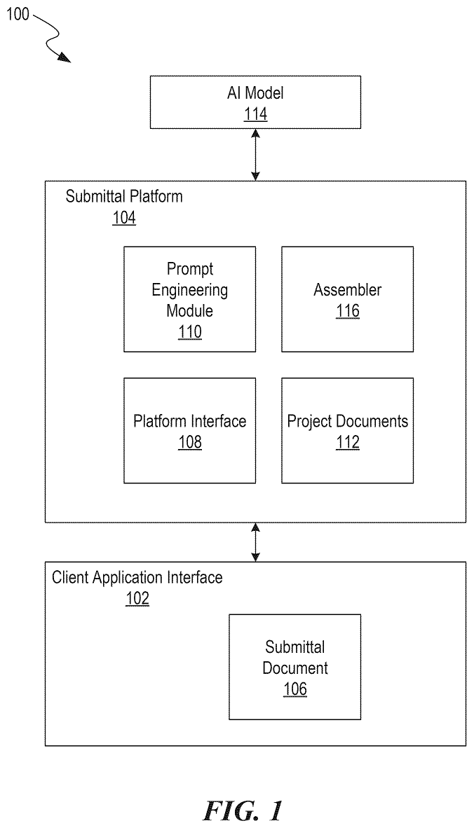

FIG. 1 is a diagram illustrating an AI submittal platform 100, according to an embodiment of the disclosed technology. The AI submittal platform 100 includes a client application interface 102 that enables users to communicate with a submittal platform 104. The client application interface 102 enables the user to provide the submittal platform 104 with a submittal document 106. The submittal platform 104 communicates with the client application interface 102 via a platform interface 108. The platform interface in turn communicates with a prompt engineering module 110. The submittal platform compares the submittal document 106 against a project document 112. The prompt engineering module 110 generates prompts for an AI model 114 based on the submittal document 106 and the project documents 112. In some embodiments the AI model 114 is an external or third party generated model accessed via an application program interface (API). In other embodiments, the AI model 114 is part of the submittal platform 104. An illustrative embodiment of the AI model 114 is a generative AI model. Output from the AI model 114 is assembled with an assembler 116 that builds the graphic user interface for the user.

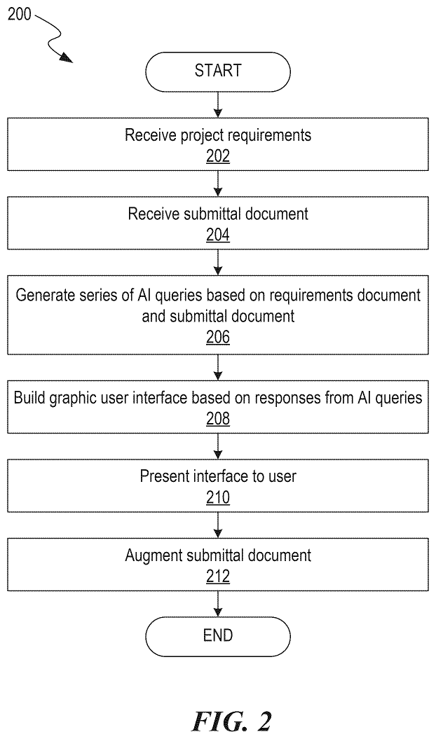

FIG. 2 is a flowchart illustrating a method of comparing submittal specs with project requirements. In step 202, a platform receives project documents. In step 204, the platform receives a submittal document. In step 206, the submittal platform generates a series of AI queries that identify relevant matchings of the project requirements and the submittal document.

The project document is expected to be voluminous and only a small subsection would be relevant to any given submittal. A first set of AI queries drills down to identify those sections. A next set of AI queries identifies whether the submittal document meaningfully matches to the requirements and evaluates the extent of the match.

In step 210, the user is presented with an interface (e.g., tripartite) that includes multiple panes that display the submittal document, the relevant subsection of the project documents, and an evaluation section that identifies the extent to which the requirements are met. Relevant matching text is highlighted and navigation within the project documents and submittal document is directed by the user selecting a given requirement from the evaluation section.

In step 212, the platform generates a final submittal document indicating human acceptance of submittal state.

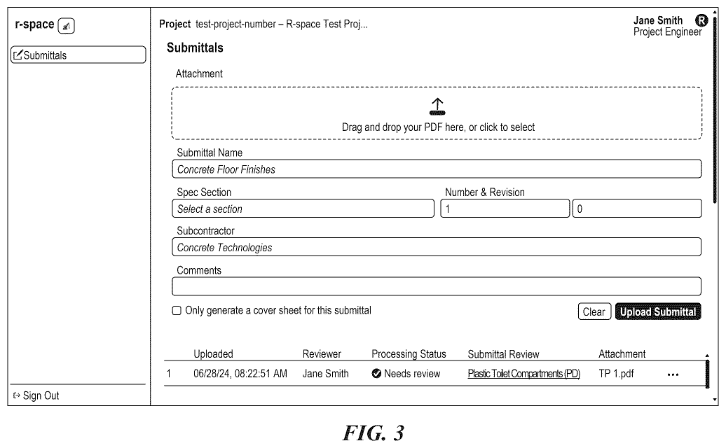

FIG. 3 is a screenshot of a first embodiment of an upload interface of a submittal platform. Submittal documents are supplied to a graphic user interface such as with a drag and drop or upload selection. In some embodiments, the user identifies which subsection of the project document the submittal is relevant to. In some embodiments, subsection identification auto-populates. Auto population is performed via any of an AI query, semantic analysis, or string matching.

As an AI query, the text of the submittal is extracted and framed into an AI query with prompt engineering instructions to compare the text to the project documents and seek a most relevant section. In some embodiments, the title page and/or a summary are given additional consideration weight. Semantic analysis or string matching performs character comparisons between the submittal and the project documents to identify matching text (e.g., either 1-to-1, or from within synonym databases).

Linking the submittal to a subsection of the project documents is used in the next phase where a tripartite interface includes both the submittal document and the requirements subsection in distinct panes.

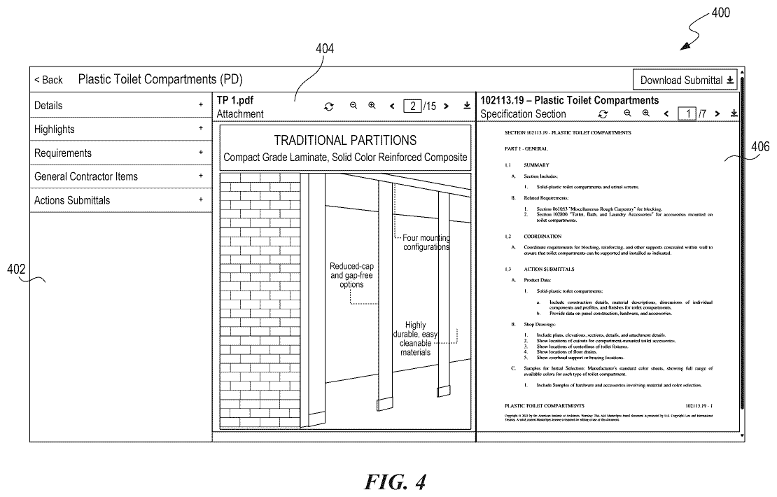

FIG. 4 is a screenshot of a first embodiment of a tripartite interface 400 of a submittal platform with collapsed details. The tripartite interface 400 includes three panes: a first pane 402, a second pane 404, and a third pane 406. The first pane 402 includes interface controls and submittal process action items. The second pane 404 is a presentation of the submittal document. The third pane 406 is a presentation of the relevant subsection of the project documents that is associated with the submittal document. Each of the panes is scrollable. The three panes are connected in a single window 500. The interface elements included in the first pane 402 are illustrative and may be reconfigured. Subsequent figures depict particular elements of an embodiment of the first pane 402, and these are intended as exemplary.

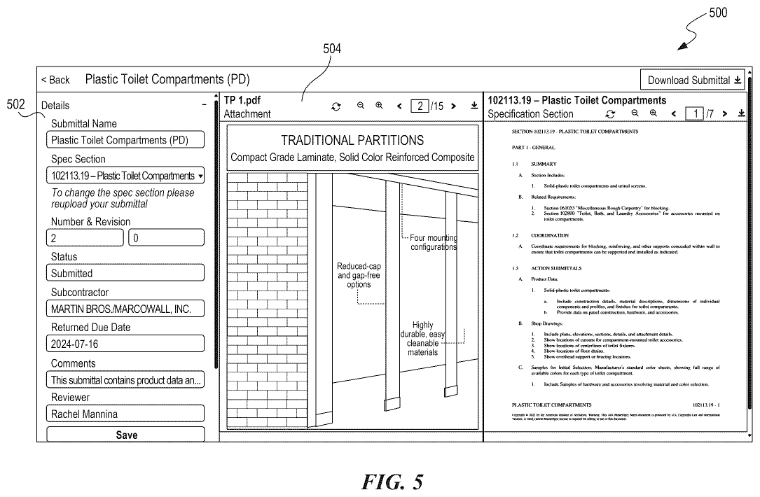

FIG. 5 is a screenshot of a first embodiment of a tripartite interface in single window 500 of a submittal platform with expanded details. The first pane 502 is depicted with an expanded details section. The details include metadata concerning the submittal included in the second pane 504. The metadata includes items that are populated directly from the submittal document itself, from a scheduling program, from an email inbox management program, or manual data entry. In some embodiments, metadata (e.g., action items remaining with respect to requirements subsections) is carried within the submittal platform. In some embodiments, the submittal name shown in pane 502 is autogenerated through a text generation model, tailored to unique project naming conventions established during project setup. This feature enforces data consistency across the project and helps the user save time by not having to re-enter this information for each submittal.

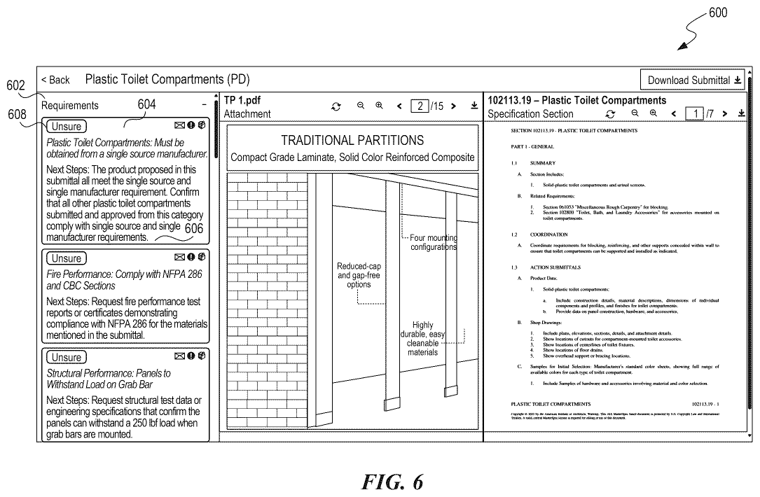

FIG. 6 is a screenshot of a first embodiment of a tripartite interface 600 of a submittal platform with a requirements evaluation pane. The first pane 602 is depicted with an expanded requirements section. The requirements are extracted from the project documents. In some embodiments, once the relevant subsection of the project document is identified, an AI query is executed based on the subsection of the project document to subdivide the text within the subsection into actionable requirements. Those identified requirements are then used to populate the listed requirements 604 of the first pane 602. The text of each requirement 606 is copied across to the first pane 602.

The listed requirements 604 are further given an evaluation 608. As depicted in the figure, the evaluation 608 is “unsure.” The evaluation 608 is based on the results of an AI query that seek to match the relevant subsection of the project documents text to the submittal document text. In this illustrative example, where the text is either wholly absent or a near match without contradiction, the evaluation 608 is indicated as “unsure.”

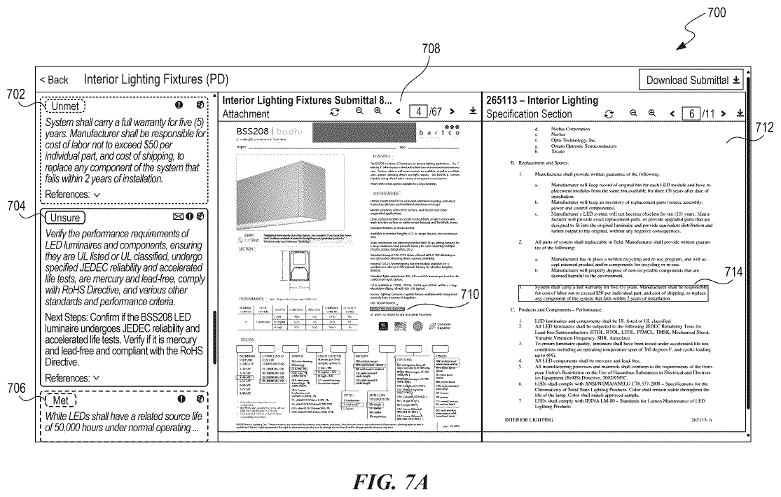

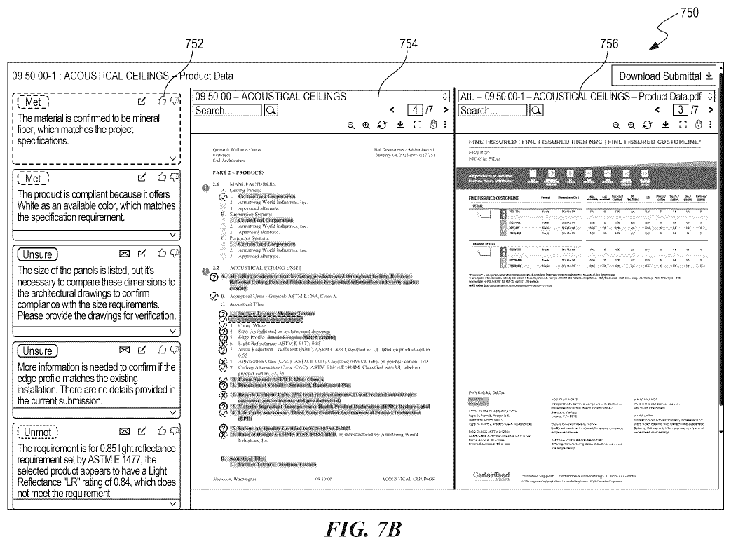

FIG. 7A is a screenshot of a second embodiment of a tripartite interface 700 of a submittal platform with a requirements evaluation pane. Depicted in the figure are a set of listed requirements 702, 704, and 706 with evaluations. The first listed requirement 702 is depicted as unmet. Support for that (“unmet”) evaluation is highlighted in the second pane 708, where a first highlighted box 710 is drawn around relevant text of the submittal document that reads on the requirement. In the third pane 712, a second highlight box 714 is drawn around the relevant requirement in the project documents.

In the depicted illustrative example, the second highlighted box 714 captures the requirement, “System shall carry a full warranty for five (5) years. Manufacturer shall be responsible for cost of labor not to exceed $50 per individual part, and cost of shipping, to replace any component of the system that fails within 2 years of installation.” This above requirement is also present in the first listed requirement 702. In the first highlighted box 710 of the second pane 708, the submittal document indicates that there is a “limited five year warranty.” These two highlighted boxes 710, 714 carry a direct contradiction (limited or full warranties) and thus the requirement 702 is indicated as unmet.

The above-described presentation repeats for each requirement 704, 706, etc., in the subsection of the project documents. Further, the interface presentation is generated automatically by employing a number of generative AI queries. The text for each requirement 702, 704, 706 is highlighted in the project documents, and the associated text (if any) is highlighted in the submittal document to enable ease of confirmation by the submittal process administrative staff.

In some embodiments, when a user mouses over or selects a given requirement 702, the highlights on the second pane 708 and third pane 712 appear. Further, in some embodiments, the second and third panes 708, 712 automatically scroll to the relevant location where the highlighted text is present.

In some embodiments, a single AI query is executed to find all requirements. In other embodiments, multiple AI queries (e.g., one for each individually, or in related batches) are executed to highlight and evaluate the status of each requirement.

FIG. 7B is a screenshot of a third embodiment of a tripartite interface 750 of a submittal platform with a requirements evaluation pane. The project documents rendered in the second pane 754 have been made fully interactive. Rather than relying solely on the requirement list in the first pane 752 to drive navigation, a user can now click directly on any clause, paragraph, or drawing callout within the second pane 754. Upon such an interaction, the system can execute a contextual lookup that scrolls the requirement list in the first pane 752 to a corresponding entry. The system can refresh the second pane 754 to surface the relevant text in the submittal document. The system can also scroll the third pane 756 to the relevant location. This multidirectional linking allows users to work natively within the documents they are most familiar with, while still benefiting from the links between panes, thereby reducing navigation issues and facilitating the overall review cycle.

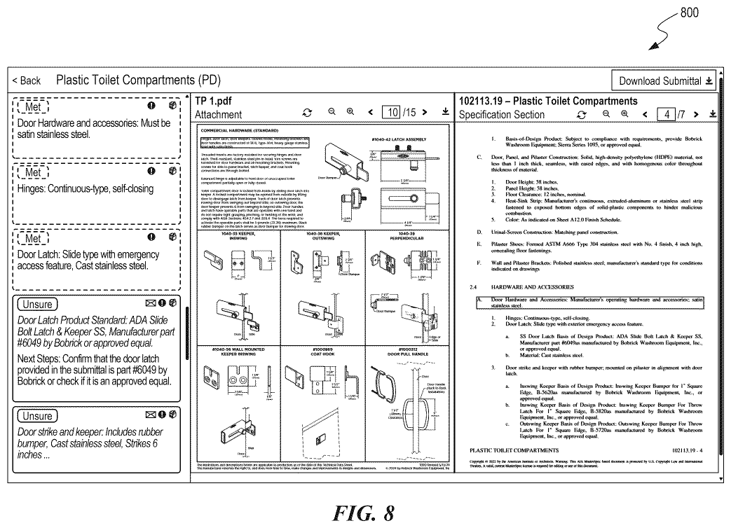

FIG. 8 is a screenshot of a fourth embodiment of a tripartite interface 800 of a submittal platform with a requirements evaluation pane. FIG. 8 provides a similar depiction as FIG. 7, although the focus is on a met requirement (e.g., here that the door hardware be made from stainless steel). Whereas FIG. 7 focuses on lighting fixtures, FIG. 8 is focused on door hardware for public bathroom compartments. In a given set of project requirements there are many sections. The project documents can be quite voluminous and the tripartite interface 800 handles each of the subsections in a similar manner (e.g., with a set of preconfigured AI queries based on the aligned documents).

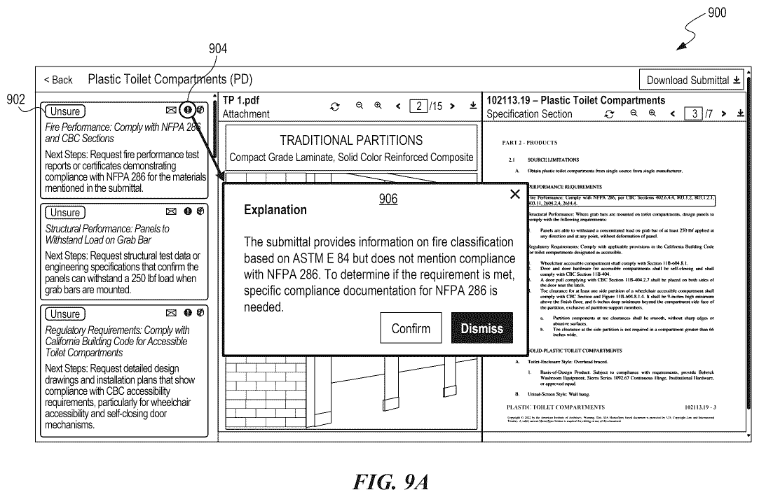

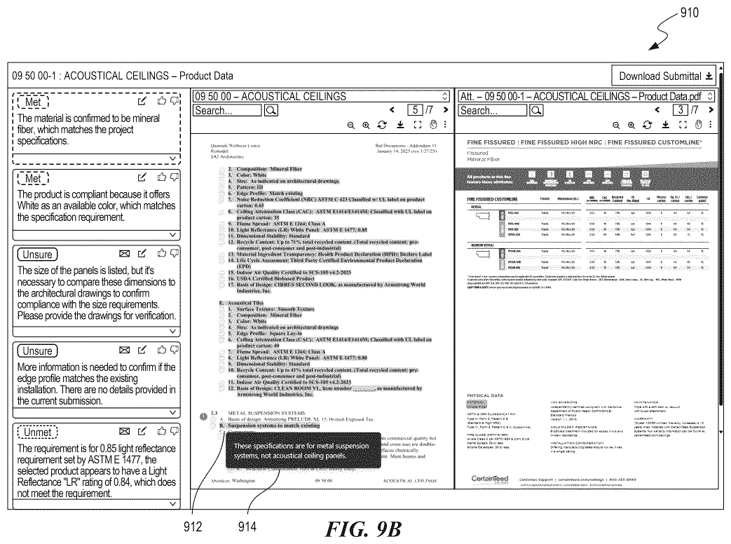

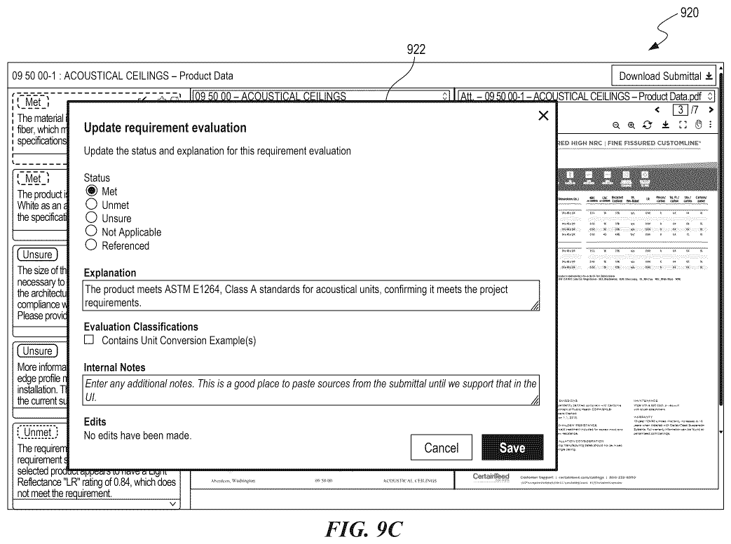

FIG. 9A is a screenshot of a first embodiment of a tripartite interface 900 of a submittal platform with a detail window 906 on the requirements evaluation pane 902. On the first (evaluation) pane 902, there are UI controls 904 that enable the user to obtain further information about a given outcome or evaluation of the requirements. For example, an explanation window 906 indicates why a given evaluation is indicated as met, unmet, or unsure. The explanation is yet another AI query, wherein the AI is asked to provide a reason to explain why a given match between a requirement and text on the submittal document is either met, unmet, or unsure.

FIG. 9B is a screenshot of a first embodiment of a tripartite interface 910 of a submittal platform with a “non-applicable” indicator 912. For example, a second pane can include a grey icon, highlighting, or other visual indicator that signifies a “non-applicable” state. Requirements determined—either automatically by the AI or manually by an administrator—to be inapplicable to the present submittal are marked with the “non-applicable” indicator 912. When the user hovers over the “non-applicable” indicator 912, a context window 914 can appear adjacent to the text or indicator, offering a brief explanation of why the clause is out of scope (for example, noting that the cited equipment is not part of the system being submitted).

FIG. 9C is a screenshot of a first embodiment of a tripartite interface 920 of a submittal platform with a window 922 for changing a requirement status. For example, a user can click directly on a requirement icon to launch the window 922. The window 922 can include options for changing the status (e.g., including options such as met, unmet, unsure, not applicable, or referenced). The user can also update an explanation, an evaluation classification, and internal notes. The window 922 can include an overview of any edits made by the user in a given instance. The user can then save the edits or cancel the operation. Any edits made by the user via the window 922 can be reflected in the requirements evaluation pane 902, as shown in FIG. 9A.

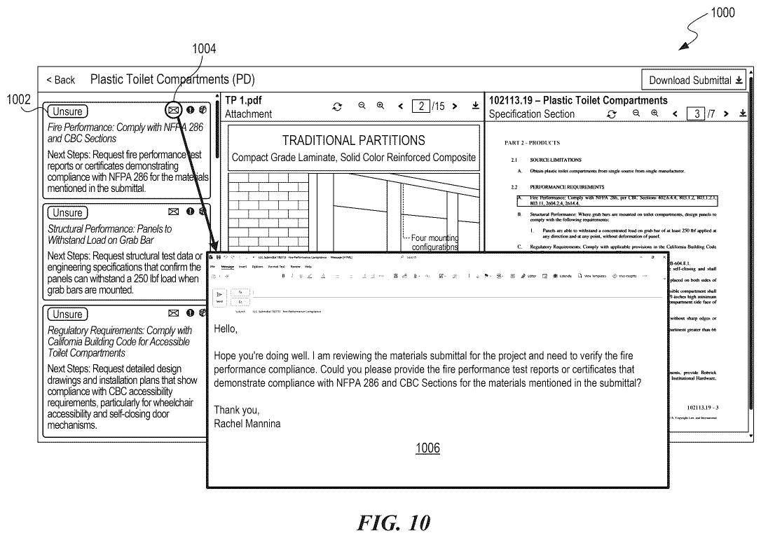

FIG. 10 is a screenshot of a first embodiment of a tripartite interface 1000 of a submittal platform with a quick contact link 1004 on the requirements evaluation pane 1002. An additional control is a quick contact link 1004 that automatically opens an email 1006 with canned text based on the requirement and the submittal document. The canned email is either AI generated or form generated based on prior output of the AI (e.g., identification of requirements and relevant text from the submittal document). In some embodiments, the used is enabled to click multiple requirements and bundle all of the selected requirements into an email to send to a contact for clarification.

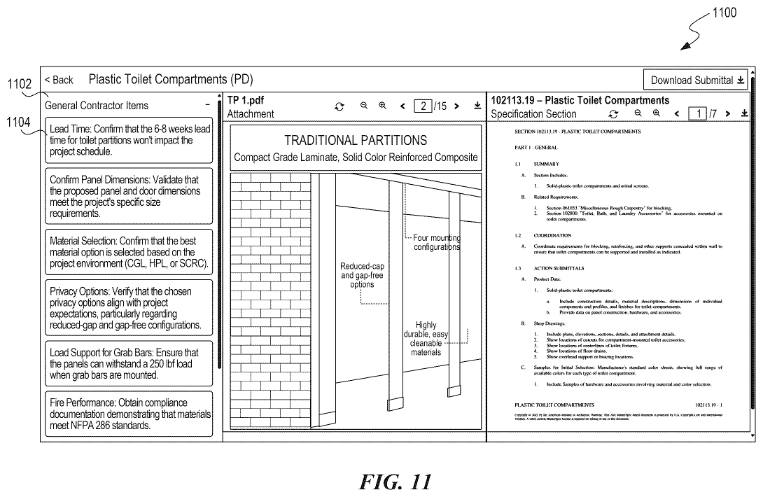

FIG. 11 is a screenshot of a first embodiment of a tripartite interface 1100 of a submittal platform with a project notes pane 1102. The project notes pane 1102 is a part of the first pane. Included therein is a set of multiple notes 1104 that the general contractor staff, or other user, should keep in mind to ensure a successful submittal approval, procurement, installation and execution of the material(s) reviewed in the submittal.

In some embodiments, this feature builds an agenda around each submittal item that is be tracked to each user. Some embodiments further include a communication platform spanning between parties that are needed to answer the action items (subcontractors, design team, developers, etc.). In an illustrative embodiment, the action items and communication platform is synced with the project schedule and the platform to provide and auto populate status's of the action items.

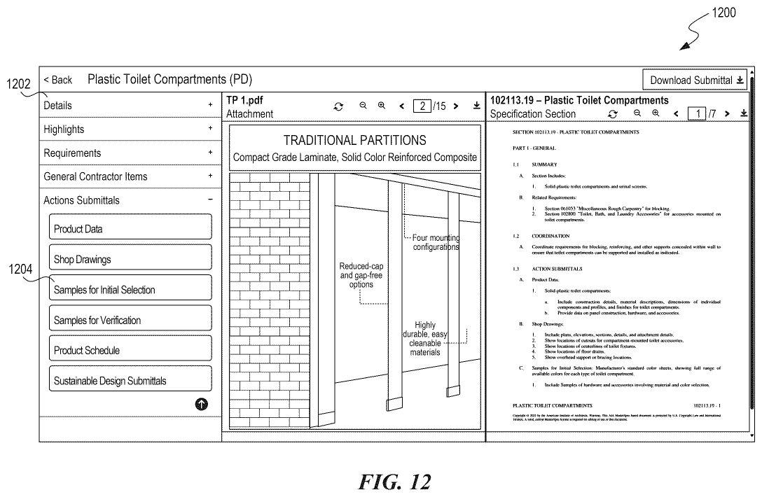

FIG. 12 is a screenshot of a first embodiment of a tripartite interface 1200 of a submittal platform with a submittal actions pane 1202. The submittal actions pane 1202 is a part of the first pane. Included therein is a set of action items 1204 for the submittals process. This section 1202 pulls all submittals that are required for the active type of product and is referred back to for each specific submittal specification section. Items that are pulled from that specification section show the user what else is required and also provide references to the specification section where it pulled that information. In some implementations, a second embodiment can actively track the submittals that are extracted in section 1202 against the submittals have been submitted to date and present this information to users in a multitude of ways. A third embodiment can generate a live (and exportable) tracking document for the user to understand each submittal submission and status against the specification requirements in 1202. The third embodiment can link to additional project information such as the project schedule to show the users how submittal approvals are tracking against the project schedule.

In some embodiments, the submittal platform can offer a customizable coversheet feature for each project. During project setup, clients can be presented with the option to use a standard coversheet provided by the system. This standard coversheet can be uniquely personalized for each client, incorporating their branding elements, project-specific information, and preferred layout. The system can allow for various levels of customization, such as including the client's logo, project name, submittal number, contractor information, and other relevant details. In some cases, the coversheet can be dynamically generated based on the information entered into the submittal platform, ensuring consistency and accuracy across all project documents. For clients who opt to use the standard coversheet, the system can automatically generate and attach it to each submittal document. This feature can help streamline the submittal process, maintain a professional appearance, and ensure that all necessary information is consistently presented on each submittal. The use of a standardized, yet customizable coversheet can also facilitate easier document management and review processes for all parties involved in the project.

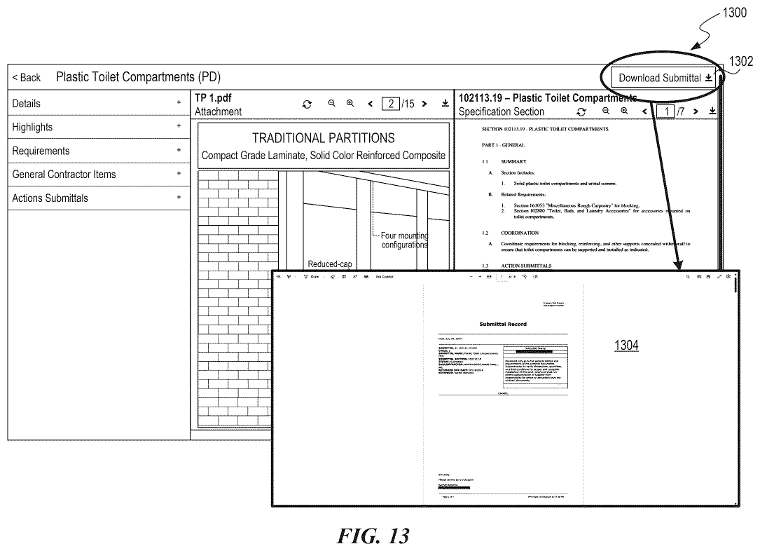

FIG. 13 is a screenshot of a first embodiment of a tripartite interface 1300 of a submittal platform with a record output control 1302. Upon completion of the submittal process, the platform enables output of a submittal coversheet 1304. The platform generates a coversheet for each submittal (clients can also have unique coversheet layouts so the coversheets can look different across clients) per the information the user inputs in the Submittals Details pane. In some embodiments, the output combines the generated coversheet with the pdf submittal and combines those elements into one pdf with the coversheet being the first page.

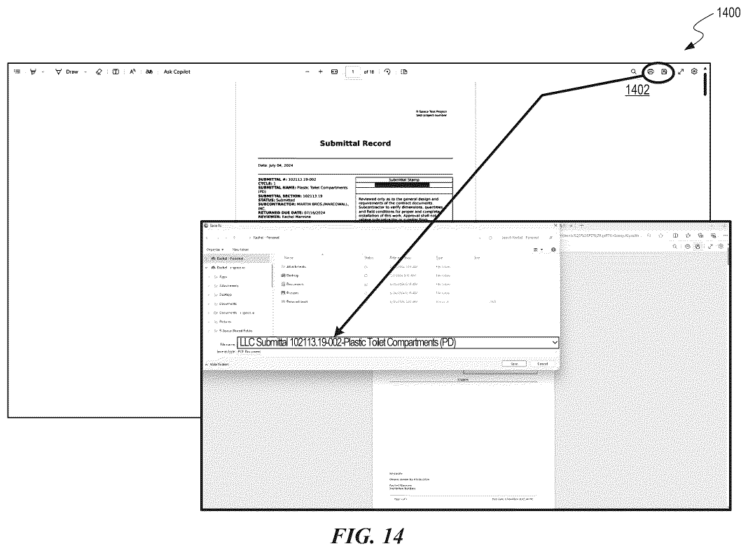

FIG. 14 is a screenshot of an embodiment of an output 1400 of a submittal platform. The submittal record of output 1400 is saved in any format the user desires, such as PDF with a save control 1402. The platform autogenerates the submittal name for a specific project.

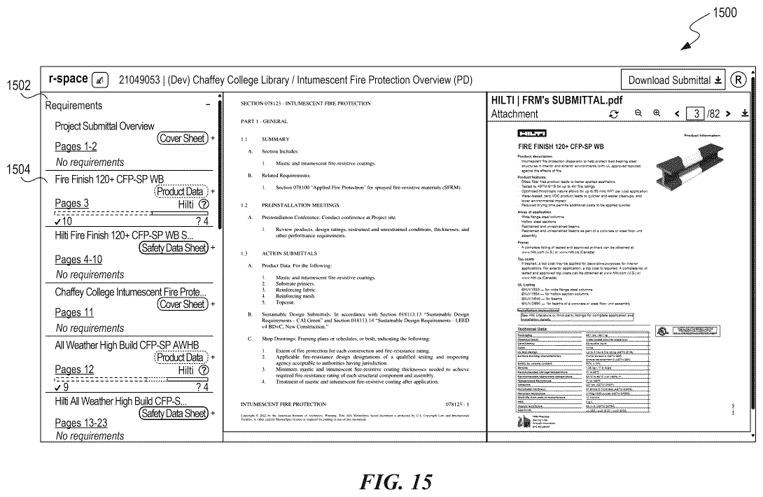

FIG. 15 is a screenshot of a first alternate embodiment of a tripartite interface 1500 of a submittal platform. The alternate interface 1500 includes a modified first pane 1502 where the requirements are presented in groups 1504 by page or content. The status of those requirements is depicted as a summary or overview of product compliance within those groups. Groups are expanded out to see the individual requirements. The depicted embodiment displays the submittal type each product is. In some embodiments, the platform employs another type of Machine Learning to derive each type-“Product Data”, “Safety Data Sheet”, etc.

In some embodiments, the groups 1504 portray a user interactive piece that relabels the submittal type when the platform's classification was incorrect. The platform then collects these user-corrected submittal types, statuses, and other relevant data to refine its classification algorithms and improve future submittal reviews through techniques such as reinforcement learning. This feedback loop not only updates the current submittal being reviewed but also enhances the accuracy of future classifications.

In some embodiments, the platform can implement a hybrid approach combining machine learning classification with human-in-the-loop verification for submittal segmentation and labeling. When a user uploads a submittal, the system can prompt them to manually segment the document and label different products and their corresponding submittal types. This manual intervention can serve as a way to ensure accuracy during the early stages of implementation, while also providing valuable training data for the machine learning models. The platform can present an interface where users can easily divide the uploaded document into distinct sections, assign product categories, and specify submittal types such as “Product Data” or “Safety Data Sheet” for each segment. In some implementations, a submittal can be segmented into multiple segments based on a single category (e.g., “Product Data”) or based on multiple categories. In some implementations, a segment can include a revision submittal, a submittal response (e.g., from a design team), or another version of a submittal. This human-guided process can complement the automated machine learning classification, allowing for a more robust and accurate categorization system. As the platform's machine learning models improve over time through continuous learning from user inputs, the reliance on manual segmentation can be gradually reduced, potentially transitioning to a fully automated process with human oversight for quality assurance.

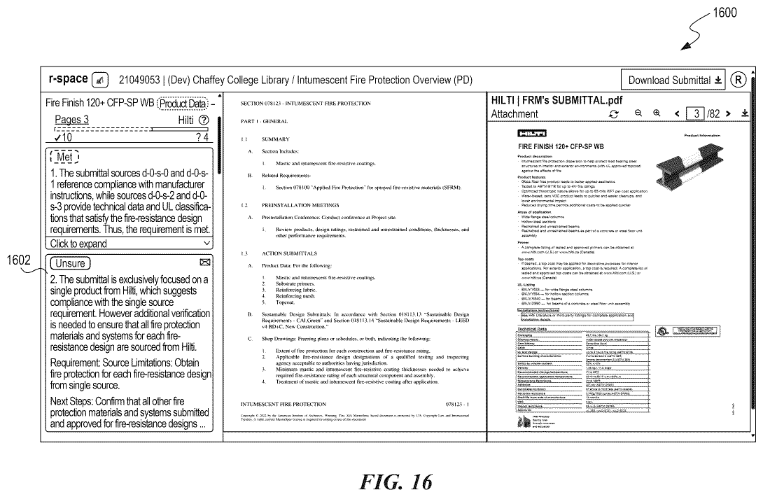

FIG. 16 is a screenshot of a second alternate embodiment of a tripartite interface 1600 of a submittal platform with a detail view. FIG. 16 displays the groups 1504 of FIG. 15 in expanded form, depicting the individual requirements 1602. The depicted embodiment shows the Explanation as the bolded top portion and under the explanation shows the requirement and next steps (if applicable).

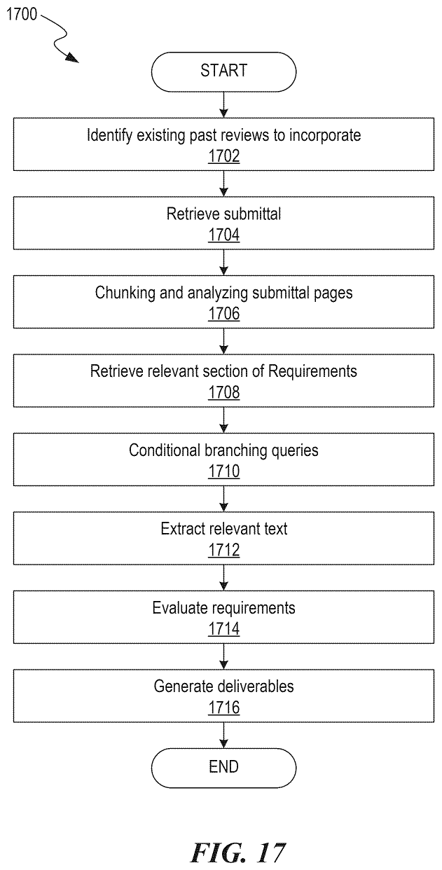

FIG. 17 Is a flow chart illustrating a method of clearing a submittal process via AI examination of documents. In step 1702, the platform determines whether existing reviews of documents exist. The platform identifies particular submittals using a unique identifier provided in the request data. The platform queries a database to retrieve any existing reviews associated with the identified submittal. The platform compiles the retrieved reviews into a structured format for subsequent processing steps.

The platform evaluates the status of past reviews: If no past reviews exist, the system proceeds with the review. If there are any reviews currently in progress, the system terminates further review actions. If all past reviews are completed, the system terminates further review actions. If the current action is a revision submittal, the system integrates past reviews into the current workflow, ensuring that any revisions requested in the previous version(s) are addressed in the new submittal. This comparison-driven approach allows the platform to focus on verifying the completeness and accuracy of the revisions, as opposed to a full initial review.

In step 1704, the platform retrieves submittal data. Upon successful retrieval, the platform compiles the submittal data into a structured format for subsequent processing steps. In step 1706, the document is chunked for analysis. The platform processes the pages in chunks, with each chunk containing a predefined number of pages (e.g., five pages per chunk). For each chunk, the platform encodes the images and prepares a user prompt to analyze the pages, including context about current documents. The platform sends the encoded images and prompts to an AI model, which analyzes the pages to determine their document types and descriptions.

The AI model classifies each page as part of specific document types, such as product data, shop drawings, safety data, table of contents, cover sheets, title pages, or other types. The AI model also provides descriptions for each identified document, ensuring unique and detailed descriptions to distinguish different documents. To enhance robustness and accuracy, the initial AI model's output may be fed into a secondary classification model. The secondary classification model re-evaluates the document types and descriptions provided by the primary AI model, serving as a fallback and validation mechanism. The secondary classification model may adjust or confirm the classifications, providing an additional layer of verification and refinement.

In step 1708, the platform retrieves the relevant specification section. The platform checks if the submittal already has a specified section ID and verifies whether reclassification is necessary. If a specification section ID is already associated with the submittal and reclassification is not required, the platform retrieves the corresponding specification section from the database. The retrieved specification section details are then updated in the state for subsequent processing steps. If no specification section ID is set or reclassification is required, the platform proceeds to classify the specification section based on the submittal content. The platform analyzes the submittal text and matches it with the available specification sections to identify the top candidate sections that are most relevant to the submittal content and generates an explanation for why each section was selected. These top candidates are stored with the review to allow the user to modify the specification section post-review in the web application. If a user selects a different specification section, the platform records this change, and a new review workflow is triggered.

These updates can also be used as feedback into the AI model to improve relevant specification section classification for future reviews. Among the top candidate sections, the platform further analyzes and selects the most relevant specification section based on a detailed comparison of the submittal text and the content of each candidate section.

In step 1710, the platform determines the comparison strategy from branching options based on prior identifications. The platform examines the submittal's review configuration to determine if it is configured for a cover sheet-only review. If so, the platform logs this information and terminates further review actions. If all conditions are satisfied, the platform proceeds with further processing of the submittal. Each different instance of a submittal within the attachment is then processed in a workflow specific to that type of submittal.

In step 1712, the platform extracts text employed for subsequent analysis. The platform checks for pre-processed structured data for requirements, action submittals and additional information needed to perform the submittal review already exists. This preprocessing step involves the same extraction process detailed throughout and is performed when the specification sections, charts, tables, figures are first configured for the project in the platform. If pre-extracted data is not available, the platform downloads the PDF file of the specification section. The platform utilizes a PDF parser to extract text content from the specification section. The text content is processed and arranged in a visually structured format to facilitate analysis.

The platform employs heuristics to identify and filter pages containing the “Action Submittals” or “Submittals” or other equivalent sections within the specification document. This typically involves detecting specific headings or patterns in the text, such as “PART 1—GENERAL” and “PART 2—PRODUCTS.” The platform groups the extracted text into blocks and assigns unique identifiers to each block. These text blocks are then formatted and combined into a prompt for the next stage of the review. By assigning unique IDs to each text block, the platform ensures that the language model's output can be precisely tied back to the original text blocks extracted from the PDF. This linkage allows the platform to maintain a clear reference to the source data, including its exact location on the PDF. The platform uses a language model to analyze the prepared text blocks and extract structured data. The model identifies and extracts metadata related to products mentioned in the specifications and associates this metadata with their respective text block IDs. The extracted action submittals, along with their titles and associated text block locations, are compiled into a structured format. The platform stores this structured data in a database to ensure that it can be quickly retrieved in future requests without needing to reprocess the PDF. The platform employs heuristics to identify and filter pages within the specification document containing sections that have product requirements. This typically involves detecting specific headings or patterns in the text, such as “PART 2—PRODUCTS”and subsequent sections.

In cases where product requirements may not be confined to a specific section like “PART2—PRODUCTS,” the platform utilizes an AI model to classify each extracted item as a product requirement or not. This classification process involves parsing the entire text content of the specification section, using an AI model trained to recognize product requirements based on context and content, and classifying each item in the text as a product requirement, ensuring that all relevant information is captured even if it appears outside the typical sections.

The platform groups the extracted text into blocks and assigns unique identifiers to each block. These text blocks are then formatted and combined into a prompt for further processing by a language model. For each identified reference to another document, the platform looks up the related document. This lookup process allows the platform to present the related documents to the user during the review. The extracted products section data, including sub-sections, requirements, and related documents, are compiled into a structured format.

The platform stores this structured data in a database to ensure that it can be quickly retrieved in future requests without needing to reprocess the PDF. The platform employs the same technique of assigning unique text block IDs to maintain a clear link between the language model's output and the original PDF source data. This technique ensures transparency and accuracy in the data extraction process.

The platform is also called upon to extract visual data such as pictures and diagrams. The platform converts the pages of the shop drawing into individual image files to facilitate detailed analysis. A computer vision system processes these images to extract key elements such as text, tables, charts, and the actual drawings themselves. The platform analyzes the extracted text and drawings from the shop drawing to match them with available project drawings, identifying the top candidate drawings that are most relevant to the submittal content. The platform further analyzes and selects the most relevant project drawings based on a detailed comparison of the shop drawing text and the content of each candidate drawing. Multiple relevant drawings may be selected as necessary.

In some embodiments, the platform is designed to handle projects that do not have specifications and rely solely on drawings or other materials for requirements. In these cases, the platform can employ specialized computer vision and AI techniques to extract requirements directly from the drawings. The process begins by converting project drawings into high-resolution images, which are then analyzed using computer vision algorithms to identify text, dimensions, notes, callouts, and other relevant information. The AI model is trained to recognize drawing conventions and standard notations used in construction drawings, enabling it to extract requirements even when they are embedded within technical drawings rather than written specifications. The platform identifies drawing elements such as detail callouts, section references, and general notes that typically contain requirements information. For each identified element, the platform extracts the text and contextual information, including its location on the drawing and any associated graphical elements. This extracted information is then processed by the AI model to identify specific requirements, similar to how it processes text from specification documents. The platform maintains the relationship between extracted requirements and their source locations on the drawings, allowing users to trace each requirement back to its original context. When a submittal is uploaded for review in a drawings-only project, the platform compares the submittal content against these drawing-derived requirements using the same AI-driven evaluation process used for specification-based reviews.

The platform converts the pages of the relevant project drawings into individual image files to facilitate detailed analysis. A computer vision system processes these images to extract key elements such as text, tables, charts, and specific drawing sections. For each key element identified in the project drawings, the platform finds the corresponding key elements in the shop drawing submittal. This matching process may involve using a large language model (LLM) to analyze the extracted elements from the project drawings, preparing a detailed prompt for the LLM that includes the key element details from the project drawings and the extracted elements from the shop drawing submittal. The LLM identifies the corresponding elements in the shop drawing submittal and provides brief descriptions of the data needed for comparison.

In step 1714, the platform evaluates the requirements found in the specification and compares them against the stored text from the submittals. The platform initializes the requirements evaluator with the parsed products section and the submittal attachment. This initialization includes setting up necessary configurations such as whether to include non-applicable requirements. For each requirement in a sub-section, the platform determines which documents from the submittal are relevant for evaluating that requirement within the specific workflow. This determination involves analyzing the requirement to understand what data is needed to evaluate compliance, preparing a detailed prompt that includes the requirement details and the list of documents in the submittal, and using a language model to analyze the prompt. The platform asks the LLM to determine if the requirement is applicable to the submittal and identify the documents that likely contain the data needed to check compliance with the requirement.

Upon receiving a response from the LLM that includes the applicability status of the requirement and a list of relevant documents with brief descriptions of the data needed from each document, the platform retrieves the relevant context from the submittal documents within each workflow. This retrieval process involves extracting specific text blocks from the identified documents, mapping each text block to a unique ID, allowing precise reference back to the source data in the PDF, and using an LLM to evaluate the text blocks and requirement details, determining which blocks are relevant to the requirement and generating short descriptions for each relevant source. The response includes observations on whether the necessary data is present in the provided pages and a list of sources with their unique IDs and short descriptions of the relevant content.

Requirements are evaluated in parallel. For each requirement, the platform evaluates its compliance based on the extracted submittal context within its specific workflow. This evaluation process involves preparing a prompt that includes the submittal sources extracted in the step above and the requirement details and using an LLM to analyze the prompt and generate an evaluation result, which includes determining whether the requirement is applicable to the submittal, assessing if the requirement is met, not met, unsure, or not applicable, providing a status explanation and next steps if necessary, and identifying the relevant sources from the submittal that support the evaluation status.

The platform compiles the results of individual requirement evaluations into a structured format within each workflow. This compilation includes aggregating the evaluation results for each requirement in all subsections, filtering out non-applicable requirements if specified, and including links to referenced documents mentioned in any applicable requirements. The platform updates the state with the compiled evaluation results from each workflow, making them available for further processing and review. The platform uses the unique IDs assigned to text blocks to maintain a clear link between the evaluation results and the original submittal and specification section sources. This linkage ensures transparency and accuracy in the evaluation process.

While the platform's AI-driven evaluation process is highly accurate, the platform can ensure compliance verification at the highest level of accuracy (e.g., 95%+) with a human-in-the-loop quality control workflow. This workflow integrates human oversight at strategic points in the review process. When a submittal is uploaded and processed by the platform, system administrators receive notifications alerting them to the new submission. These administrators (e.g., experienced construction professionals) can then access the platform to review the AI-generated evaluations before they are finalized. The human review focuses particularly on complex requirements where context or industry knowledge might be crucial for accurate assessment. Administrators can modify AI-generated evaluations, add commentary, adjust reference links, or provide additional context that might not have been captured by the automated system. The platform can record these human interventions, using them as labeled training data to continuously improve the AI model's performance. This feedback loop helps the system learn from expert human judgment, gradually reducing the need for human intervention over time. The human-in-the-loop process is especially important for critical submittals where errors could have significant project impacts. For routine submittals with straightforward requirements, the level of human oversight can be reduced as the system demonstrates consistent accuracy. This balanced approach ensures both efficiency and the highest level of accuracy in the submittal review process.

In step 1716, the platform generates outputs such as a final submittal output and automatically generated emails to relevant contractors. The platform ensures that each generated email is linked back to the specific requirement and submittal context. This linking process involves including unique identifiers for each requirement in the email metadata and ensuring that the emails reference the relevant sections of the submittal and specification for clarity. Upon completion of the review, the platform generates a notification indicating that the review process for the specified submittal has been completed. The notification includes details such as the submittal name, review ID, and a summary of the review highlights, if any.

The platform is designed to support multiple user interfaces tailored to different stakeholders in the construction process, not only the General Contractor (GC). Separate interfaces can be provided for subcontractors, architects, engineers, owners, and other project participants, each with functionality specific to their role in the submittal process. The subcontractor interface, for example, can allow subcontractors to initiate the submittal process by uploading their submittal documents directly into the system. When a subcontractor uploads a submittal, the platform automatically processes it, segments the documents, classifies each document type, and routes it to the appropriate GC user for review. For example, once a subcontractor uploads submittal documents, the platform can perform the same processes as described within the patent for processing the submittal. These processes can include segmenting documents, classifying each document type, providing a submittal review interface through which each party can provide comments, and tagging any comments for visibility by subsequent parties (e.g., creating a clear tracking record of requirements and resolution notes). This can remove the need for the GC to manually input submittals received from subcontractors. The architect/engineer interface provides specialized tools for final approval and markup of submittals, while maintaining the same AI-powered evaluation capabilities. Each interface maintains consistent core functionality while adapting to the specific needs and permissions appropriate to each user type. The platform can integrate with project management systems (such as Procore, Autodesk Construction Cloud, and other construction management platforms) through APIs, enabling seamless data flow throughout the submittal lifecycle. These integrations allow for automatic retrieval of submittals when they are uploaded to the connected platform, eliminating the need for manual uploads. When a submittal is uploaded to a connected platform, the system automatically detects it through webhooks, retrieves it via API, and initiates the review process.

Similarly, when a review is completed, the platform can automatically push the reviewed submittal back to the connected platform, notifying the next party in the review chain. Beyond basic document transfer, these API integrations enable the platform to collect valuable metadata such as submittal time spent in review, revision time per subcontractor, and other performance metrics. This data is used to build analytics dashboards that provide insights into submittal process efficiency, helping teams identify bottlenecks and improve workflows. The platform brings together all relevant information for each submittal review, including not just the primary specification section but also multiple “reference” specification sections when applicable. This comprehensive approach ensures that requirements that might be spread across different sections of the project documents are all considered during the review process. In some embodiments, this approach is able to flag conflicting information or requirements across applicable project documents, facilitating the identification of scope inconsistencies or gaps.

### Computing Platform

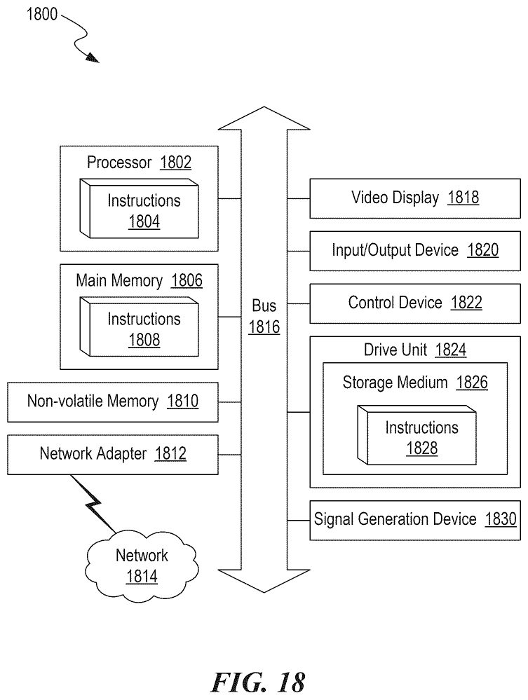

FIG. 18 is a block diagram illustrating an example computer system 1800, in accordance with one or more embodiments. In some embodiments, components of the example computer system 1800 are used to implement the software platforms described herein. At least some operations described herein can be implemented on the computer system 1800.

In some embodiments, the computer system 1800 includes one or more central processing units (“processors”) 1802, main memory 1806, non-volatile memory 1810, network adapters 1812 (e.g., network interface), video displays 1818, input/output devices 1820, control devices 1822 (e.g., keyboard and pointing devices), drive units 1824 including a storage medium 1826, and a signal generation device 1820 that are communicatively connected to a bus 1816. The bus 1816 is illustrated as an abstraction that represents one or more physical buses and/or point-to-point connections that are connected by appropriate bridges, adapters, or controllers. The bus 1816, therefore, includes a system bus, a peripheral component interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1894 bus (also referred to as “Firewire”).

In some embodiments, the computer system 1800 shares a similar computer processor architecture as that of a desktop computer, tablet computer, personal digital assistant (PDA), mobile phone, game console, music player, wearable electronic device (e.g., a watch or fitness tracker), network-connected (“smart”) device (e.g., a television or home assistant device), virtual/augmented reality systems (e.g., a head-mounted display), or another electronic device capable of executing a set of instructions (sequential or otherwise) that specify action(s) to be taken by the computer system 1800.

While the main memory 1806, non-volatile memory 1810, and storage medium 1826 (also called a “machine-readable medium”) are shown to be a single medium, the terms “machine-readable medium” and “storage medium” should be taken to include a single medium or multiple media (e.g., a centralized/distributed database and/or associated caches and servers) that store one or more sets of instructions 1828. The term “machine-readable medium” and “storage medium” shall also be taken to include any medium that is capable of storing, encoding, or carrying a set of instructions for execution by the computer system 1800. In some embodiments, the non-volatile memory 1810 or the storage medium 1826 is a non-transitory, computer-readable storage medium storing computer instructions, which is executable by one or more “processors” 1802 to perform functions of the embodiments disclosed herein.

In general, the routines executed to implement the embodiments of the disclosure can be implemented as part of an operating system or a specific application, component, program, object, module, or sequence of instructions (collectively referred to as “computer programs”). The computer programs typically include one or more instructions (e.g., instructions 1804, 1808, 1828) set at various times in various memory and storage devices in a computer device. When read and executed by one or more processors 1802, the instruction(s) cause the computer system 1800 to perform operations to execute elements involving the various aspects of the disclosure.

Moreover, while embodiments have been described in the context of fully functioning computer devices, those skilled in the art will appreciate that the various embodiments are capable of being distributed as a program product in a variety of forms. The disclosure applies regardless of the particular type of machine or computer-readable media used to actually affect the distribution.

Further examples of machine-readable storage media, machine-readable media, or computer-readable media include recordable-type media such as volatile and non-volatile memory 1810, floppy and other removable disks, hard disk drives, optical discs (e.g., compact disc read-only memory (CD-ROMS), digital versatile discs (DVDs)), and transmission-type media such as digital and analog communication links.

The network adapter 1812 enables the computer system 1800 to mediate data in a network 1814 with an entity that is external to the computer system 1800 through any communication protocol supported by the computer system 1800 and the external entity. The network adapter 1812 includes a network adapter card, a wireless network interface card, a router, an access point, a wireless router, a switch, a multilayer switch, a protocol converter, a gateway, a bridge, a bridge router, a hub, a digital media receiver, and/or a repeater.

In some embodiments, the network adapter 1812 includes a firewall that governs and/or manages permission to access proxy data in a computer network and tracks varying levels of trust between different machines and/or applications. The firewall is any number of modules having any combination of hardware and/or software components able to enforce a predetermined set of access rights between a particular set of machines and applications, machines and machines, and/or applications and applications (e.g., to regulate the flow of traffic and resource sharing between these entities). In some embodiments, the firewall additionally manages and/or has access to an access control list that details permissions, including the access and operation rights of an object by an individual, a machine, and/or an application, and the circumstances under which the permission rights stand.

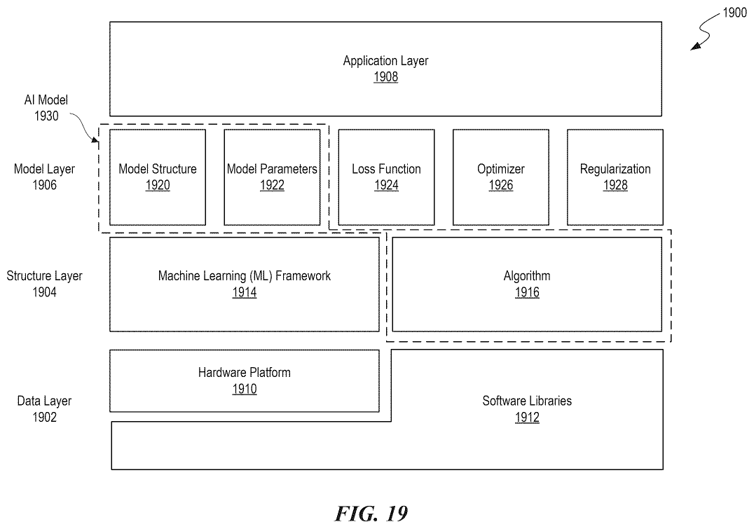

The techniques introduced here can be implemented by programmable circuitry (e.g., one or more microprocessors), software and/or firmware, special purpose hardwired (i.e., non-programmable) circuitry, or a combination of such forms. Special-purpose circuitry can be in the form of one or more application-specific integrated circuits (ASICs), programmable logic devices (PLDs), field-programmable gate arrays (FPGAs), etc. A portion of the methods described herein can be performed using the example ML system 1900 illustrated and described in more detail with reference to FIG. 19.

### AI System

FIG. 19 is a high-level block diagram illustrating an example AI system, in accordance with one or more embodiments. The AI system 1900 is implemented using components of the example computer system 1800 illustrated and described in more detail with reference to FIG. 18. Likewise, embodiments of the AI system 1900 can include different and/or additional components or be connected in different ways.

In some embodiments, as shown in FIG. 19, the AI system 1900 includes a set of layers, which conceptually organize elements within an example network topology for the AI system's architecture to implement a particular AI model 1930. Generally, an AI model 1930 is a computer-executable program implemented by the AI system 1900 that analyzes data to make predictions. Information passes through each layer of the AI system 1900 to generate outputs for the AI model 1930. The layers include a data layer 1902, a structure layer 1904, a model layer 1906, and an application layer 1908. The algorithm 1916 of the structure layer 1904 and the model structure 1920 and model parameters 1922 of the model layer 1906 together form the example AI model 1930. The optimizer 1926, loss function engine 1924, and regularization engine 1928 work to refine and optimize the AI model 1930, and the data layer 1902 provides resources and support for the application of the AI model 1930 by the application layer 1908.

The data layer 1902 acts as the foundation of the AI system 1900 by preparing data for the AI model 1930. As shown, in some embodiments, the data layer 1902 includes two sub-layers: a hardware platform 1910 and one or more software libraries 1912. The hardware platform 1910 is designed to perform operations for the AI model 1930 and includes computing resources for storage, memory, logic, and networking, such as the resources described in relation to FIG. 1. The hardware platform 1910 processes amounts of data using one or more servers. The servers can perform backend operations such as matrix calculations, parallel calculations, machine learning (ML) training, and the like. Examples of servers used by the hardware platform 1910 include central processing units (CPUs) and graphics processing units (GPUs). CPUs are electronic circuitry designed to execute instructions for computer programs, such as arithmetic, logic, controlling, and input/output (I/O) operations, and can be implemented on integrated circuit (IC) microprocessors. GPUs are electric circuits that were originally designed for graphics manipulation and output but may be used for AI applications due to their vast computing and memory resources. GPUs use a parallel structure that generally makes their processing more efficient than that of CPUs. In some instances, the hardware platform 1910 includes Infrastructure as a Service (IaaS) resources, which are computing resources, (e.g., servers, memory, etc.) offered by a cloud services provider. In some embodiments, the hardware platform 1910 includes computer memory for storing data about the AI model 1930, application of the AI model 1930, and training data for the AI model 1930. In some embodiments, the computer memory is a form of random-access memory (RAM), such as dynamic RAM, static RAM, and non-volatile RAM.

In some embodiments, the software libraries 1912 are thought of as suites of data and programming code, including executables, used to control the computing resources of the hardware platform 1910. In some embodiments, the programming code includes low-level primitives (e.g., fundamental language elements) that form the foundation of one or more low-level programming languages, such that servers of the hardware platform 1910 can use the low-level primitives to carry out specific operations. The low-level programming languages do not require much, if any, abstraction from a computing resource's instruction set architecture, allowing them to run quickly with a small memory footprint. Examples of software libraries 1912 that can be included in the AI system 1900 include Intel Math Kernel Library, Nvidia cuDNN, Eigen, and Open BLAS.

In some embodiments, the structure layer 1904 includes an ML framework 1914 and an algorithm 1916. The ML framework 1914 can be thought of as an interface, library, or tool that allows users to build and deploy the AI model 1930. In some embodiments, the ML framework 1914 includes an open-source library, an application programming interface (API), a gradient-boosting library, an ensemble method, and/or a deep learning toolkit that works with the layers of the AI system to facilitate development of the AI model 1930. For example, the ML framework 1914 distributes processes for the application or training of the AI model 1930 across multiple resources in the hardware platform 1910. In some embodiments, the ML framework 1914 also includes a set of pre-built components that have the functionality to implement and train the AI model 1930 and allow users to use pre-built functions and classes to construct and train the AI model 1930. Thus, the ML framework 1914 can be used to facilitate data engineering, development, hyperparameter tuning, testing, and training for the AI model 1930. Examples of ML frameworks 1914 that can be used in the AI system 1900 include TensorFlow, PyTorch, Scikit-Learn, Keras, Caffe, LightGBM, Random Forest, and Amazon Web Services.

In some embodiments, the algorithm 1916 is an organized set of computer-executable operations used to generate output data from a set of input data and can be described using pseudocode. In some embodiments, the algorithm 1916 includes complex code that allows the computing resources to learn from new input data and create new/modified outputs based on what was learned. In some implementations, the algorithm 1916 builds the AI model 1930 through being trained while running computing resources of the hardware platform 1910. The training allows the algorithm 1916 to make predictions or decisions without being explicitly programmed to do so. Once trained, the algorithm 1916 runs the computing resources as part of the AI model 1930 to make predictions or decisions, improve computing resource performance, or perform tasks. The algorithm 1916 is trained using supervised learning, unsupervised learning, semi-supervised learning, and/or reinforcement learning. The application layer 1908 describes how the AI system 1900 is used to solve problems or perform tasks.

As an example, to train an AI model 1930 that is intended to model human language (also referred to as a language model), the data layer 1902 is a collection of text documents, referred to as a text corpus (or simply referred to as a corpus). The corpus represents a language domain (e.g., a single language), a subject domain (e.g., scientific papers), and/or encompasses another domain or domains, be they larger or smaller than a single language or subject domain. For example, a relatively large, multilingual, and non-subject-specific corpus is created by extracting text from online web pages and/or publicly available social media posts. In some embodiments, data layer 1902 is annotated with ground truth labels (e.g., each data entry in the training dataset is paired with a label), or unlabeled.

Training an AI model 1930 generally involves inputting into an AI model 1930 (e.g., an untrained ML model) data layer 1902 to be processed by the AI model 1930, processing the data layer 1902 using the AI model 1930, collecting the output generated by the AI model 1930 (e.g., based on the inputted training data), and comparing the output to a desired set of target values. If the data layer 1902 is labeled, the desired target values, in some embodiments, are, e.g., the ground truth labels of the data layer 1902. If the data layer 1902 is unlabeled, the desired target value is, in some embodiments, a reconstructed (or otherwise processed) version of the corresponding AI model 1930 input (e.g., in the case of an autoencoder) or is a measure of some target observable effect on the environment (e.g., in the case of a reinforcement learning agent). The parameters of the AI model 1930 are updated based on a difference between the generated output value and the desired target value. For example, if the value outputted by the AI model 1930 is excessively high, the parameters are adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the AI model 1930 typically is to minimize a loss function or maximize a reward function.

In some embodiments, the data layer 1902 is a subset of a larger data set. For example, a data set is split into three mutually exclusive subsets: a training set, a validation (or cross-validation) set, and a testing set. The three subsets of data, in some embodiments, are used sequentially during AI model 1930 training. For example, the training set is first used to train one or more ML models, each AI model 1930, e.g., having a particular architecture, having a particular training procedure, being describable by a set of model hyperparameters, and/or otherwise being varied from the other of the one or more ML models. The validation (or cross-validation) set, in some embodiments, is then used as input data into the trained ML models to, e.g., measure the performance of the trained ML models and/or compare performance between them. In some embodiments, where hyperparameters are used, a new set of hyperparameters is determined based on the measured performance of one or more of the trained ML models, and the first step of training (e.g., with the training set) begins again on a different ML model described by the new set of determined hyperparameters. These steps are repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) begins in some embodiments. The output generated from the testing set, in some embodiments, is compared with the corresponding desired target values to give a final assessment of the trained ML model's accuracy. Other segmentations of the larger data set and/or schemes for using the segments for training one or more ML models are possible.

Backpropagation is an algorithm for training an AI model 1930. Backpropagation is used to adjust (also referred to as update) the value of the parameters in the AI model 1930, with the goal of optimizing the objective function. For example, a defined loss function is calculated by forward propagation of an input to obtain an output of the AI model 1930 and a comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively so that the loss function is converged or minimized. In some embodiments, other techniques for learning the parameters of the AI model 1930 are used. The process of updating (or learning) the parameters over many iterations is referred to as training. In some embodiments, training is carried out iteratively until a convergence condition is met (e.g., a predefined maximum number of iterations has been performed, or the value outputted by the AI model 1930 is sufficiently converged with the desired target value), after which the AI model 1930 is considered to be sufficiently trained. The values of the learned parameters are then fixed and the AI model 1930 is then deployed to generate output in real-world applications (also referred to as “inference”).

In some examples, a trained ML model is fine-tuned, meaning that the values of the learned parameters are adjusted slightly in order for the ML model to better model a specific task. Fine-tuning of an AI model 1930 typically involves further training the ML model on a number of data samples (which may be smaller in number/cardinality than those used to train the model initially) that closely target the specific task. For example, an AI model 1930 for generating natural language that has been trained generically on publicly available text corpora is, e.g., fine-tuned by further training using specific training samples. In some embodiments, the specific training samples are used to generate language in a certain style or a certain format. For example, the AI model 1930 is trained to generate a blog post having a particular style and structure with a given topic.

Some concepts in ML-based language models are now discussed. It may be noted that, while the term “language model” has been commonly used to refer to a ML-based language models, there could exist non-ML language models. In the present disclosure, the term “language model” may be used as shorthand for an ML-based language model (i.e., a language model that is implemented using a neural network or other ML architecture), unless stated otherwise. For example, unless stated otherwise, the “language model” encompasses LLMs.

In some embodiments, the language model uses a neural network (typically a DNN) to perform NLP tasks. A language model is trained to model how words relate to each other in a textual sequence, based on probabilities. In some embodiments, the language model contains hundreds of thousands of learned parameters, or in the case of a large language model (LLM) contains millions or billions of learned parameters or more. As non-limiting examples, a language model can generate text, translate text, summarize text, answer questions, write code (e.g., Python, JavaScript, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistance).

In recent years, there has been interest in a type of neural network architecture, referred to as a transformer, for use in language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

Although a general transformer architecture for a language model and the model's theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that is considered to be an encoder-only language model. A decoder-only language model accepts embeddings as input and uses auto-regression to generate an output text sequence. Transformer-XL and GPT-type models are language models that are considered to be decoder-only language models.

Because GPT-type language models tend to have a large number of parameters, these language models are considered LLMs. An example of a GPT-type LLM is GPT-4. GPT-4 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2,048 input tokens), and is able to generate a large number of tokens as output (e.g., up to 2,048 tokens). GPT-4 has been trained as a generative model, meaning that GPT-4 can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-4, via a software interface (e.g., an API). Additionally or alternatively, such a remote language model can be accessed via a network such as, for example, the Internet. In some implementations, such as, for example, potentially in the case of a cloud-based language model, a remote language model is hosted by a computer system that includes a plurality of cooperating (e.g., cooperating via a network) computer systems that are in, for example, a distributed arrangement. Notably, a remote language model employs a plurality of processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real-time or near real-time) can require the use of a plurality of processors/cooperating computing devices as discussed above.

In some embodiments, inputs to an LLM are referred to as a prompt (e.g., command set or instruction set), which is a natural language input that includes instructions to the LLM to generate a desired output. In some embodiments, a computer system generates a prompt that is provided as input to the LLM via the LLM's API. As described above, the prompt is processed or pre-processed into a token sequence prior to being provided as input to the LLM via the LLM's API. A prompt includes one or more examples of the desired output, which provides the LLM with additional information to enable the LLM to generate output according to the desired output. Additionally or alternatively, the examples included in a prompt provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples is referred to as a zero-shot prompt.

In some embodiments, the llama family of models is used as an LLM, which is an LLM based on an encoder-decoder architecture and can simultaneously perform text generation and text understanding. The llama selects or trains proper pre-training corpus, pre-training targets, and pre-training parameters according to different tasks and fields and adjusts an LLM on the basis so as to improve the performance of the LLM under a specific scene.

In some embodiments, the Falcon40B is used as an LLM, which is a causal decoder-only model. During training, the model predicts the subsequent tokens with a causal language modeling task. The model applies rotational positional embeddings in the model's transformer model and encodes the absolution positional information of the tokens into a rotation matrix.

In some embodiments, the Claude is used as an LLM, which is an autoregressive model trained on a large text corpus unsupervised.

Consequently, alternative language and synonyms can be used for any one or more of the terms discussed herein, and no special significance is to be placed upon whether or not a term is elaborated or discussed herein. Synonyms for certain terms are provided. A recital of one or more synonyms does not exclude the use of other synonyms. The use of examples anywhere in this specification including examples of any term discussed herein is illustrative only and is not intended to further limit the scope and meaning of the disclosure or of any exemplified term. Likewise, the disclosure is not limited to various embodiments given in this specification.

It is to be understood that the embodiments and variations shown and described herein are merely illustrative of the principles of this invention and that various modifications can be implemented by those skilled in the art.

Note that any and all of the embodiments described above can be combined with each other, except to the extent that it may be stated otherwise above or to the extent that any such embodiments might be mutually exclusive in function and/or structure.

Although the present invention has been described with reference to specific exemplary embodiments, it will be recognized that the invention is not limited to the embodiments described but can be practiced with modification and alteration within the spirit and scope of the appended claims. Accordingly, the specification and drawings are to be regarded in an illustrative sense rather than a restrictive sense.

What is claimed is:

1. A method for displaying a tripartite graphic user interface for linked document navigation, the method comprising:
receiving a plurality of electronic construction project artifacts associated with a construction project, the plurality of electronic construction project artifacts comprising a submittal and one or more reference documents, the one or more reference documents comprising at least one of drawings, specifications, or previous submittal versions;
parsing the plurality of electronic construction project artifacts to extract a plurality of informational items, each informational item indicating a requirement, an action, or a scope;
causing display of a graphical user interface comprising:
a first pane configured to present the plurality of informational items extracted from the plurality of electronic construction project artifacts,
a second pane configured to present at least a portion of the submittal, and
a third pane configured to present at least a portion of the one or more reference documents,
wherein the first pane, the second pane, and the third pane store location identifiers that associate each informational item in the first pane with (i) a first corresponding location within the submittal displayed in the second pane and (ii) a second corresponding location within the one or more reference documents displayed in the third pane, and
wherein the first pane, the second pane, and the third pane are configured such that a selection of an informational item in the first pane causes display of corresponding portions in the second pane and the third pane based on the location identifiers; and
generating, in response to a user interaction with an informational item of the plurality of informational items via the graphical user interface, an action object comprising data generated based on the informational item and a reference to a first respective portion of the submittal and a second respective portion of the one or more reference documents.

2. The method of claim 1, further comprising automatically exporting the action object, via an application programming interface (API), to an external application that is associated with a type of the action object.

3. The method of claim 1, wherein the first pane, the second pane, and the third pane are configured such that a selection of a particular portion of the submittal displayed in the second pane causes display of corresponding portions in the first pane and the third pane based on the location identifiers.

4. The method of claim 1, wherein the action object comprises at least one of:
a scope change,
a request for information (RFI),
an email,
a requirement indicator;
a new submittal or a submittal revision, or
submittal revision notes.

5. The method of claim 1, wherein the parsing comprises inputting, into an artificial intelligence (AI) model, the plurality of electronic construction project artifacts and a series of prompts to cause the AI model to extract the plurality of informational items from the plurality of electronic construction project artifacts, identify corresponding portions of the submittal and the one or more reference documents for the plurality of informational items, and link the plurality of informational items with the corresponding portions of the submittal and the one or more reference documents using the location identifiers.

6. The method of claim 1, wherein the parsing comprises:
applying natural language processing and image analysis algorithms to the plurality of electronic construction project artifacts to identify and extract the plurality of informational items, and
linking each informational item to the first respective portion of the submittal and the second respective portion of the one or more reference documents.

7. The method of claim 1, wherein the plurality of electronic construction project artifacts further comprises a drawing, and wherein the parsing comprises applying an image analysis algorithm to the drawing to extract one or more informational items indicating one or more requirements from the drawing.

8. A system for displaying construction project artifacts via a tripartite graphic user interface, the system comprising:
a processor; and
a memory including a training data set and instructions that, when executed, cause the processor to:
receive a plurality of electronic construction project artifacts associated with a construction project, the plurality of electronic construction project artifacts comprising a submittal and one or more reference documents;
parsing the plurality of electronic construction project artifacts to extract a plurality of informational items, each informational item indicating a requirement, an action, or a scope;
causing display of a graphical user interface comprising:
a first pane configured to present the plurality of informational items extracted from the plurality of electronic construction project artifacts,
a second pane configured to present at least a portion of the submittal, and
a third pane configured to present at least a portion of the one or more reference documents,
wherein the first pane, the second pane, and the third pane store location identifiers that associate each informational item in the first pane with (i) a first corresponding location within the submittal displayed in the second pane and (ii) a second corresponding location within the one or more reference documents displayed in the third pane, and
wherein the first pane, the second pane, and the third pane are configured such that a selection of an informational item in the first pane causes display of corresponding portions in the second pane and the third pane based on the location identifiers; and
generating, in response to a user interaction with an informational item of the plurality of informational items via the graphical user interface, an action object comprising data generated based on the informational item and a reference to a first respective portion of the submittal and a second respective portion of the one or more reference documents.

9. The system of claim 8, further comprising automatically exporting the action object, via an application programming interface (API), to an external application that is associated with a type of the action object.

10. The system of claim 8, wherein the first pane, the second pane, and the third pane are configured such that a selection of a particular portion of the submittal displayed in the second pane causes display of corresponding portions in the first pane and the third pane based on the location identifiers.

11. The system of claim 8, wherein the action object comprises at least one of:
a scope change,
a request for information (RFI),
an email,
a requirement indicator;
a new submittal or a submittal revision, or
submittal revision notes.

12. The system of claim 8, wherein the instructions for parsing further cause the processor to input, into an artificial intelligence (AI) model, the plurality of electronic construction project artifacts and a series of prompts to cause the AI model to extract the plurality of informational items from the plurality of electronic construction project artifacts, identify corresponding portions of the submittal and the one or more reference documents for the plurality of informational items, and link the plurality of informational items with the corresponding portions of the submittal and the one or more reference documents using the location identifiers.

13. The system of claim 8, wherein the instructions for parsing further cause the processor to:
apply natural language processing and image analysis algorithms to the plurality of electronic construction project artifacts to identify and extract the plurality of informational items, and
link each informational item to the first respective portion of the submittal and the second respective portion of the one or more reference documents.

14. The system of claim 8, wherein the plurality of electronic construction project artifacts further comprises a drawing, and wherein the parsing comprises applying an image analysis algorithm to the drawing to extract one or more informational items indicating one or more requirements from the drawing.

15. A computer-implemented method comprising:
receiving a plurality of electronic construction project artifacts associated with a construction project, the plurality of electronic construction project artifacts comprising a submittal and one or more reference documents;
causing display of a graphical user interface comprising:
a submittal pane configured to present at least a portion of the submittal, and
a reference pane configured to present at least a portion of the one or more reference documents,
wherein the submittal pane and the reference pane store location identifiers that associate a first corresponding location within the submittal displayed in the submittal pane and a second corresponding location within the one or more reference documents displayed in the reference pane, and
wherein the submittal pane and the reference pane are configured such that a selection of a particular portion of the submittal displayed in the submittal pane causes display of a corresponding portion in the reference pane based on the location identifiers; and
generating, in response to a user interaction with the graphical user interface, an output comprising a reference to a first respective portion of the submittal and a second respective portion of the one or more reference documents.

16. The computer-implemented method of claim 15, wherein the graphical user interface further comprises an informational pane configured to present a plurality of informational items extracted from the plurality of electronic construction project artifacts, and
wherein the submittal pane, the reference pane, and the informational pane are configured such that a selection of a particular portion of the submittal displayed in the submittal pane causes display of corresponding portions in the informational pane and the reference pane based on the location identifiers, and
wherein the submittal pane, the reference pane, and the informational pane are configured such that a selection of an informational item displayed in the informational pane causes display of corresponding portions in the submittal pane and the reference pane based on the location identifiers.

17. The computer-implemented method of claim 16, wherein generating the output further comprises generating, in response to a user interaction with an informational item of the plurality of informational items via the graphical user interface, an action object comprising data generated based on the informational item and a reference to the first respective portion of the submittal and the second respective portion of the one or more reference documents.

18. The computer-implemented method of claim 17, wherein the action object comprises at least one of:
a scope change,
a request for information (RFI),
an email,
a requirement indicator;
a new submittal or a submittal revision, or
submittal revision notes.

19. The computer-implemented method of claim 15, further comprising:
parsing the plurality of electronic construction project artifacts to extract a plurality of informational items, each informational item indicating a requirement, an action, or a scope,
wherein the parsing further comprises inputting, into an artificial intelligence (AI) model, the plurality of electronic construction project artifacts and a series of prompts to cause the AI model to extract the plurality of informational items from the plurality of electronic construction project artifacts, identify corresponding portions of the submittal and the one or more reference documents for the plurality of informational items, and link the plurality of informational items with the corresponding portions of the submittal and the one or more reference documents using the location identifiers.

20. The computer-implemented method of claim 19, wherein the parsing further comprises:
applying natural language processing and image analysis algorithms to the plurality of electronic construction project artifacts to identify and extract the plurality of informational items, and
linking each informational item to the first respective portion of the submittal and the second respective portion of the one or more reference documents.
